(19) United States
(12) Patent Application Publication
(10) Pub. No.: US 2019/0109817 A1
(43) Pub. Date: Apr. 11, 2019

(54) SYSTEM AND METHOD FOR AIRCRAFT DATA LOADING USING CABIN GATEWAYS

(71) Applicant: Honeywell International Inc., Morris Plains, NJ (US)

(72) Inventors: Carol Rogers, Phoenix, AZ (US); John Peterson, Phoenix, AZ (US); Adam Sheppard, Montclair, NJ (US); Francois Goudal, Chantilly (FR); Petr Simon, Brno (CZ)

(73) Assignee: Honeywell International Inc., Morris Plains, NJ (US)

(21) Appl. No.: 15/913,329

(22) Filed: Mar. 6, 2018

(30) Foreign Application Priority Data
Oct. 11, 2017 (FR) 1759537

(51) Int. Cl. H04L 29/06; H04L 29/08; H04L 12/66

(52) U.S. Cl. CPC H04L 63/0209; H04L 12/66; H04L 67/12

(57) ABSTRACT

A system and method for data loading in a vehicle is disclosed. The system comprises a cabin gateway onboard the vehicle, with the gateway including a data load software application module; an onboard switch and storage unit in operative communication with the gateway; and an onboard vehicle electronics unit in operative communication with the switch and storage unit. The gateway is configured to communicate with one or more wide area networks, and is configured to communicate with a portable device and a secure ground portal. The gateway is operative to initiate a remote transfer of data from one or more ground servers through the one or more wide area networks to the vehicle, and to store the data onboard the vehicle. The data load software application module in the gateway includes instructions, executable by a processor, for loading the stored data into the vehicle electronics unit.

This application claims the benefit of priority to FR Application No. 1759537, filed on Oct. 11, 2017, the disclosure of which is incorporated by reference.

### BACKGROUND

There is a need to regularly load data into vehicles such as aircraft, including database files, avionics configuration files, aircraft personality module (APM) files, loadable software airplane parts (LSAPs), and the like. Database files, in particular, are usually updated and loaded every fourteen days.

Older vehicles such as legacy aircraft typically do not have wireless access to the avionics for data loading. In such aircraft, data loading is provided through the cockpit using physical connections. File staging is done via manual processes, which are prone to errors and incorrect file transfers. For example, current procedures require maintenance personnel to transfer data from a portable memory device into the memory of an onboard data loading drive. The maintenance personnel then connect a laptop computer to the avionics system to initiate the data load.

Updating cockpit avionics in legacy aircraft with wireless gateways and automatic file staging solutions is very costly and time consuming. Accordingly, there is a need to find a way to automatically bring files to the aircraft and wirelessly load the files, without expensive updates to the cockpit avionics.

### SUMMARY

A system and method for data loading in a vehicle is disclosed. The system comprises a cabin gateway onboard the vehicle, with the gateway including a data load software application module; an onboard switch and storage unit in operative communication with the gateway; and an onboard vehicle electronics unit in operative communication with the switch and storage unit. The gateway is configured to communicate with one or more wide area networks, and is configured to communicate with a portable device and a secure ground portal. The gateway is operative to initiate a remote transfer of data from one or more ground servers through the one or more wide area networks to the vehicle, and to store the data onboard the vehicle. The data load software application module in the gateway includes instructions, executable by a processor, for loading the stored data into the vehicle electronics unit.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a system for vehicle data loading using a cabin gateway, according to one embodiment;

FIG. 2 is a block diagram of a system for aircraft data loading using a cabin gateway or router, according to another embodiment; and

FIG. 3 is a flow diagram of an exemplary method for data loading in a vehicle.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A system and method for vehicle data loading such as aircraft data loading is disclosed. The system and method use cabin gateways such as passenger gateways to securely stage the data and provide a way to wirelessly load the data into the vehicle electronics such as avionics without a necessary investment in equipment upgrades such as in the cockpit.

The present system and method provide for staging and loading of certified data on certified avionics through non-certified devices such as a gateway device, and staging and loading of certified data on non-certified avionics such as a gateway device. The present system and method can also be adapted to support the download of information from an aircraft.

The present approach can significantly reduce maintenance costs, and aircraft downtime. For example, cabin avionics are typically a lower Design Assurance Level (DAL) (e.g., DAL E) and as such, software development, updates, and the like are significantly less expensive than a DAL for a cockpit (e.g. DAL D and above).

Further details of the system and method are described hereafter with reference to the drawings.

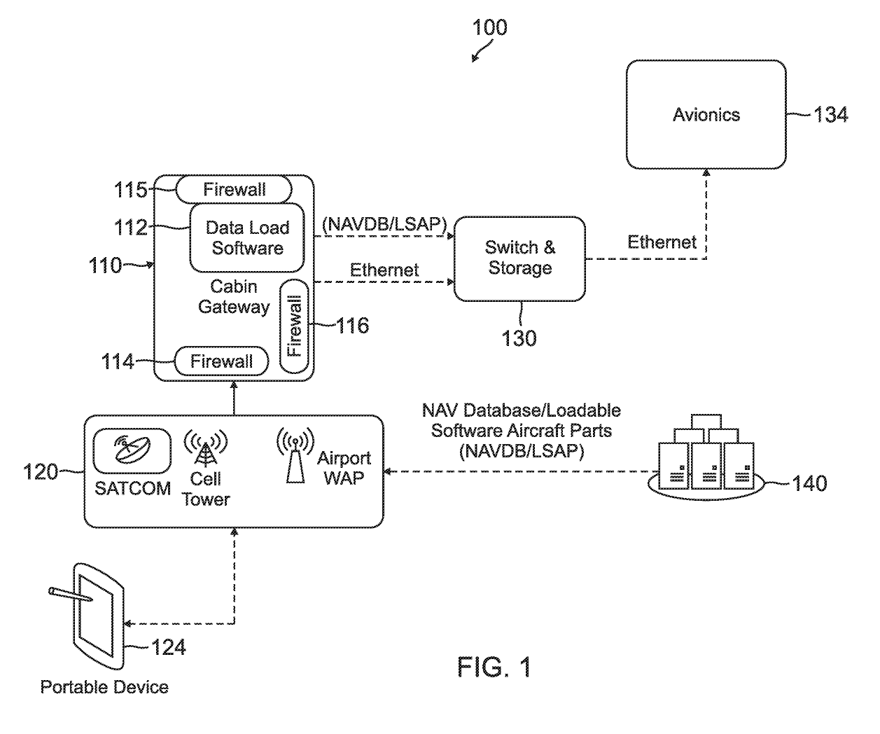

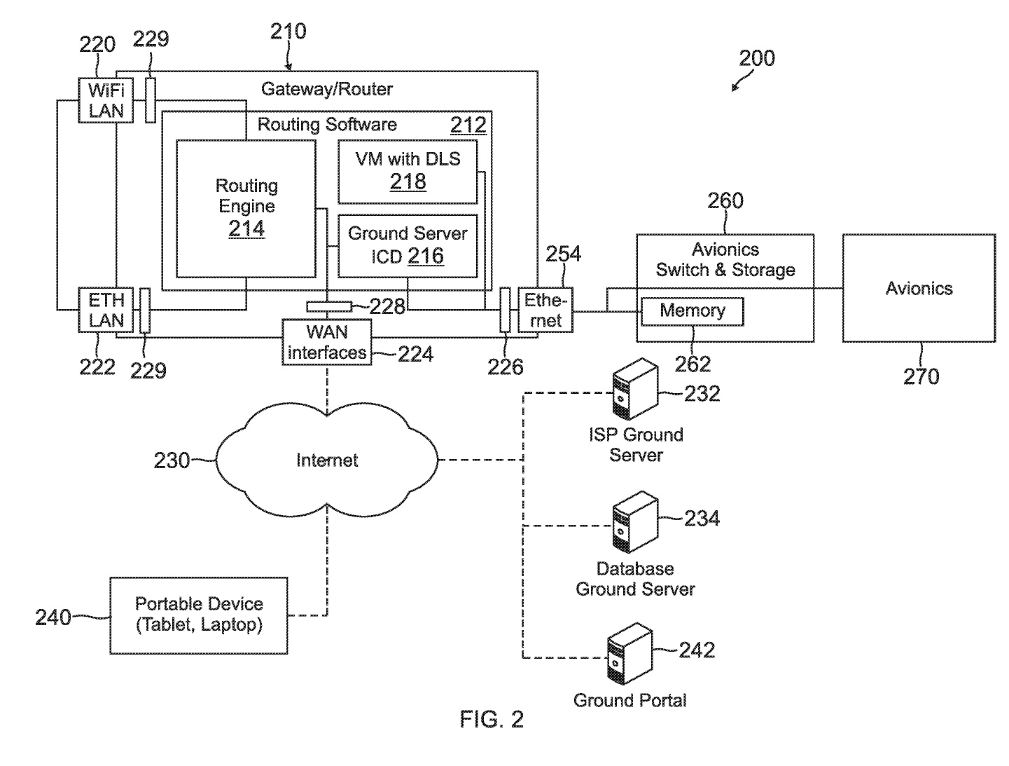

FIG. 1 illustrates a system 100 for data loading in a vehicle such as an aircraft, according to one embodiment. The system 100 includes a cabin gateway 110, which includes a data load software application module 112. The cabin gateway 110 operatively communicates with one or more wide area networks (WANs) 120, such as a satellite communications (SATCOM) network, a cellular network, an airport wireless application protocol (WAP) network, the Internet, or the like. In addition, cabin gateway 110 is configured to communicate with a portable device 124 such as a tablet or laptop computer through WANs 120. The cabin gateway 110 is also configured to communicate with a secure ground portal such as ground portal 242 (FIG. 2) through WANs 120. The secure ground portal is controllable by portable device 124 through WANs 120.

The cabin gateway 110 includes a first firewall 114 configured to provide appropriate security measures for communications with WANs 120, a second firewall 115 configured to provide appropriate security measures for a local area network (LAN) such as a Wi-Fi LAN. An onboard switch and storage unit 130 operatively communicates with cabin gateway 110, such as through an Ethernet connection secured by a third firewall 116. An onboard vehicle electronics unit such as an avionics unit 134 operatively communicates with switch and storage unit 130, such as through an Ethernet connection.

During operation of system 100, a user selects the data to be loaded by using the ground portal via portable device 124, which communicates the selection to cabin gateway 110. The cabin gateway 110 communicates with one or more ground servers 140 through the one or more WANs 120, and initiates a remote data transfer of the selected data back to cabin gateway 110. When the vehicle is an aircraft, the remote data transfer is only allowed when aircraft weight on wheels (WoW) and/or a maintenance switch is enabled. The transferred data, such as a navigation (NAV) database (DB) or loadable software aircraft parts (LSAP), is stored (staged) onboard for data loading at a later time (or immediately). For example, the data can be stored in cabin gateway 110 or on switch and storage unit 130 with appropriate security measures being taken. The data loading can then be initiated by a user from portable device 124 while the aircraft weight on wheels (WoW) and/or the maintenance switch is enabled. The data load software application module 112 in cabin gateway 110 includes instructions, executable by a processor, for loading the stored data into avionics unit 134.

FIG. 2 illustrates a system 200 for data loading in an aircraft, according to another embodiment. The system 200 includes a cabin network gateway/router 210, which includes a routing software application module 212 that operatively communicates with various data sources and devices. The routing software application module 212 includes a routing engine 214, a ground server interface control document (ICD) 216, and a virtual machine (VM) 218 with data loading software (DLS). The routing software application module 212 provides for communication between a cabin LAN, such as a Wi-Fi LAN 220 and an Ethernet (ETH) LAN 222, and wide area network (WAN) interfaces 224, through routing engine 214.

The routing software application module 212 communicates through WAN interfaces 224 with various ground servers through a WAN 230 such as the Internet, for example. Exemplary ground servers include an Internet service provider (ISP) ground server 232, a database ground server 234, and the ground portal 242. In addition, routing software application module 212 is configured to communicate with a portable device 240, such as a tablet or laptop computer, through a WAN interfaces 224.

The gateway/router 210 also includes a first firewall 226 configured to provide appropriate security measures for communications with an avionics switch and storage unit 260, and a second firewall 228 configured to provide appropriate security measures for communications through WAN interfaces 224. A third firewall 229 is configured to provide appropriate security measures for communications through WiFi LAN 220 and ETH LAN 222. The gateway/router 210 can also implement software resource partitioning.

An onboard avionics switch and storage unit 260, such as a data LAN management unit (DLMU), operatively communicates with gateway/router 210, such as through an Ethernet connection 254, and includes at least one memory device 262. An onboard avionics unit 270 operatively communicates with switch and storage unit 260, such as through an Ethernet connection.

During operation of system 200, a user selects the data to be loaded by using ground portal 242 via portable device 240 connected to the Internet, which communicates the selection to routing software application module 212, which in turn pings ISP ground server 232 or database ground server 234 to initiate a remote data transfer of the selected data back to gateway/router 210. The remote data transfer is only allowed when the aircraft weight on wheels (WoW) and/or maintenance switch is enabled. The transferred data is stored (staged) onboard the aircraft in memory device 262 of switch and storage unit 260 after passing through ground server ICD 216. The data loading can then be initiated by a user from portable device 240 any time after storing the data. The data loading software in virtual machine 218 includes instructions, executable by a processor, for loading the stored data into avionics unit 270 after receiving a command from portable device 240 to load the data. A validation of the data loading is then performed such as with conventional techniques.

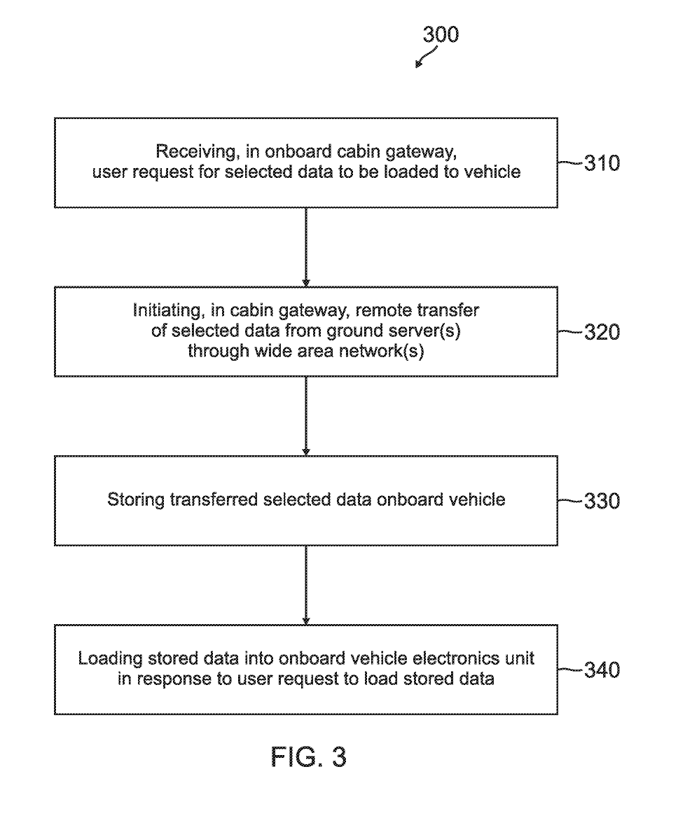

FIG. 3 is a flow diagram of an exemplary method 300 for data loading in a vehicle such as an aircraft. The method 300 includes receiving, in an onboard cabin gateway, a user request for selected data to be loaded to the vehicle (block 310). The method 300 then initiates, in the cabin gateway, a remote transfer of the selected data from one or more ground servers through one or more WANs (block 320). The transferred selected data is then stored onboard the vehicle (block 330). The stored data can them be loaded into an onboard vehicle electronics unit, such as an avionics unit, in response to a user request to load the stored data (block 340). The user requests for selected data and to load the data can be received from a portable device with a secure ground portal.

A processor used in the present system can be implemented using software, firmware, hardware, or any appropriate combination thereof, as known to one of skill in the art. These may be supplemented by, or incorporated in, specially-designed application-specific integrated circuits (ASICs) or field programmable gate arrays (FPGAs). The computer or processor can also include functions with software programs, firmware, or other computer readable instructions for carrying out various process tasks, calculations, and control functions used in the present method and system.

The present method can be implemented by computer executable instructions, such as program modules or components, which are executed by at least one processor. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer- or processor-readable instructions. These instructions are typically stored on any appropriate computer program product that includes a computer readable medium used for storage of computer readable instructions or data structures. Such a computer readable medium can be any available media that can be accessed by a general purpose or special purpose computer or processor, or any programmable logic device.

Suitable processor-readable media may include storage or memory media such as magnetic or optical media. For example, storage or memory media may include conventional hard disks, compact disks, or other optical storage disks; volatile or non-volatile media such as Random Access Memory (RAM); Read Only Memory (ROM), Electrically Erasable Programmable ROM (EEPROM), flash memory, and the like; or any other media that can be used to carry or store desired program code in the form of computer executable instructions or data structures.

### Example Embodiments

Example 1 includes a system for data loading in a vehicle, the system comprising: a cabin gateway onboard the vehicle, the gateway including a data load software application module; an onboard switch and storage unit in operative communication with the gateway; and an onboard vehicle electronics unit in operative communication with the switch and storage unit; wherein the gateway is configured to communicate with one or more wide area networks, and is configured to communicate with a portable device and a secure ground portal; wherein the gateway is operative to initiate a remote transfer of data from one or more ground servers through the one or more wide area networks to the vehicle, and to store the data onboard the vehicle; wherein the data load software application module in the gateway includes instructions, executable by a processor, for loading the stored data into the vehicle electronics unit.

Example 2 includes the system of Example 1, wherein the vehicle comprises an aircraft, and the vehicle electronics unit comprises an avionics unit.

Example 3 includes the system of any of Examples 1-2, wherein the gateway includes a first firewall configured to provide security measures for communications with the one or more wide area networks, a second firewall configured to provide security measures for communications with a local area network (LAN), and a third firewall configured to provide security measures for communications with the switch and storage unit.

Example 4 includes the system of any of Examples 1-3, wherein the switch and storage unit is in operative communication with the gateway through an Ethernet connection.

Example 5 includes the system of any of Examples 1-4, wherein the vehicle electronics unit is in operative communication with the switch and storage unit through an Ethernet connection.

Example 6 includes the system of any of Examples 1-5, wherein the one or more wide area networks comprise a satellite communications (SATCOM) network, a cellular network, an airport wireless application protocol (WAP) network, or the Internet.

Example 7 includes the system of any of Examples 1-6, wherein data for the remote transfer is selectable by a user of the portable device via the secure ground portal.

Example 8 includes the system of any of Examples 1-7, wherein the data is stored in the gateway, or in the switch and storage unit.

Example 9 includes the system of any of Examples 1-8, wherein the stored data comprises a navigation database, or loadable software aircraft parts.

Example 10 includes the system of any of Examples 1-9, wherein the stored data is selectable for loading into the vehicle electronics unit by a user of the portable device.

Example 11 includes a method for data loading in a vehicle, the method comprising: receiving, in an onboard cabin gateway, a user request for selected data to be loaded to the vehicle; initiating, in the gateway, a remote transfer of the selected data from one or more ground servers through one or more wide area networks; storing the transferred selected data onboard the vehicle; and loading the stored data into an onboard vehicle electronics unit in response to a user request to load the stored data.

Example 12 includes the method of Example 11, wherein the vehicle comprises an aircraft, and the vehicle electronics unit comprises an avionics unit.

Example 13 includes the method of Example 12, wherein the remote transfer of the selected data is only initiated when aircraft weight on wheels or a maintenance switch is enabled.

Example 14 includes the method of any of Examples 11-13, wherein the gateway includes a first firewall configured to provide security measures for communications with the one or more wide area networks, a second firewall configured to provide security measures for communications with a local area network (LAN), and a third firewall configured to provide security measures for communications with an onboard switch and storage unit.

Example 15 includes the method of any of Examples 11-14, wherein the one or more wide area networks comprise a satellite communications (SATCOM) network, a cellular network, an airport wireless application protocol (WAP) network, or the Internet.

Example 16 includes the method of any of Examples 11-15, wherein the user request for selected data is received from a secure ground portal controlled by a portable device.

Example 17 includes the method of any of Examples 11-16, wherein the gateway operatively communicates with an onboard switch and storage unit, which operatively communicates with the vehicle electronics unit.

Example 18 includes the method of Example 17, wherein the transferred selected data is stored in the gateway, or in the switch and storage unit.

Example 19 includes the method of any of Examples 11-18, wherein the transferred selected data comprises a navigation database, or loadable software aircraft parts.

Example 20 includes a computer program product, comprising: a non-transitory computer readable medium having instructions stored thereon, executable by a processor, to perform a method for data loading in an aircraft, the method comprising: receiving, in an onboard cabin gateway/router, a user request for selected data to be loaded to the aircraft; initiating, in the gateway/router, a remote transfer of the selected data from one or more ground servers through one or more wide area networks; storing the transferred selected data onboard the aircraft; and loading the stored data into an onboard avionics unit in response to a user request to load the stored data.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system for data loading in a vehicle, the system comprising:
a cabin gateway onboard the vehicle, the gateway including a data load software application module;
an onboard switch and storage unit in operative communication with the gateway; and
an onboard vehicle electronics unit in operative communication with the switch and storage unit;
wherein the gateway is configured to communicate with one or more wide area networks, and is configured to communicate with a portable device and a secure ground portal;
wherein the gateway is operative to initiate a remote transfer of data from one or more ground servers through the one or more wide area networks to the vehicle, and to store the data onboard the vehicle;
wherein the data load software application module in the gateway includes instructions, executable by a processor, for loading the stored data into the vehicle electronics unit.

2. The system of claim 1, wherein the vehicle comprises an aircraft, and the vehicle electronics unit comprises an avionics unit.

3. The system of claim 1, wherein the gateway includes a first firewall configured to provide security measures for communications with the one or more wide area networks, a second firewall configured to provide security measures for communications with a local area network (LAN), and a third firewall configured to provide security measures for communications with the switch and storage unit.

4. The system of claim 1, wherein the switch and storage unit is in operative communication with the gateway through an Ethernet connection.

5. The system of claim 1, wherein the vehicle electronics unit is in operative communication with the switch and storage unit through an Ethernet connection.

6. The system of claim 1, wherein the one or more wide area networks comprise a satellite communications (SATCOM) network, a cellular network, an airport wireless application protocol (WAP) network, or the Internet.

7. The system of claim 1, wherein data for the remote transfer is selectable by a user of the portable device via the secure ground portal.

8. The system of claim 1, wherein the data is stored in the gateway, or in the switch and storage unit.

9. The system of claim 1, wherein the stored data comprises a navigation database, or loadable software aircraft parts.

10. The system of claim 1, wherein the stored data is selectable for loading into the vehicle electronics unit by a user of the portable device.

11. A method for data loading in a vehicle, the method comprising:
receiving, in an onboard cabin gateway, a user request for selected data to be loaded to the vehicle;
initiating, in the gateway, a remote transfer of the selected data from one or more ground servers through one or more wide area networks;
storing the transferred selected data onboard the vehicle; and
loading the stored data into an onboard vehicle electronics unit in response to a user request to load the stored data.

12. The method of claim 11, wherein the vehicle comprises an aircraft, and the vehicle electronics unit comprises an avionics unit.

13. The method of claim 12, wherein the remote transfer of the selected data is only initiated when aircraft weight on wheels or a maintenance switch is enabled.

14. The method of claim 11, wherein the gateway includes a first firewall configured to provide security measures for communications with the one or more wide area networks, a second firewall configured to provide security measures for communications with a local area network (LAN), and a third firewall configured to provide security measures for communications with an onboard switch and storage unit.

15. The method of claim 11, wherein the one or more wide area networks comprise a satellite communications (SATCOM) network, a cellular network, an airport wireless application protocol (WAP) network, or the Internet.

16. The method of claim 11, wherein the user request for selected data is received from a secure ground portal controlled by a portable device.

17. The method of claim 11, wherein the gateway operatively communicates with an onboard switch and storage unit, which operatively communicates with the vehicle electronics unit.

18. The method of claim 17, wherein the transferred selected data is stored in the gateway, or in the switch and storage unit.

19. The method of claim 11, wherein the transferred selected data comprises a navigation database, or loadable software aircraft parts.

20. A computer program product, comprising:
a non-transitory computer readable medium having instructions stored thereon, executable by a processor, to perform a method for data loading in an aircraft, the method comprising:
receiving, in an onboard cabin gateway/router, a user request for selected data to be loaded to the aircraft;
initiating, in the gateway/router, a remote transfer of the selected data from one or more ground servers through one or more wide area networks;
storing the transferred selected data onboard the aircraft; and
loading the stored data into an onboard avionics unit in response to a user request to load the stored data.
